(19) United States
(12) Patent Application Publication
(10) Pub. No.: US 2001/0030642 A1
(43) Pub. Date: Oct. 18, 2001

(54) Methods and apparatus for virtual touchscreen computer interface controller

(76) Inventors: Alan Sullivan, White Plains, NY (US); John Snuffer, New York, NY (US)

Correspondence Address: Brown Raysman Millstein Felder & Steiner LLP, 900 Third Avenue, New York, NY, 10022-4728, US

(21) Appl. No.: 09/826,532

(22) Filed: Apr. 4, 2001

Related U.S. Application Data
(60) Provisional application No. 60/194,739, filed on Apr. 5, 2000.

(51) Int. Cl. G09G 5/08

(52) U.S. Cl. 345/157

(57) ABSTRACT

An interface controller for a computer or other data processor which does not require physical contact between a pointing device and the controller. Methods and apparatus are disclosed for detecting coordinates associated with the violation of a plane or field in space by a pointing device such as a user's finger, and using the detected coordinates as input for controlling a data processor such as a digital computer. The interface controller is especially useful for controlling computers in which the user is presented not with a physical interface screen such as a CRT monitor, but with a projected virtual image of the screen.

This application claims the benefit of United States Provisional patent application Ser. No. 60/194,739, filed Apr. 5, 2000 and entitled Virtual Touchscreen.

### BACKGROUND OF THE INVENTION

The invention disclosed herein relates generally to computer interface controllers. More particularly, the invention relates to methods and apparatus for interface controllers suitable for use with virtual computer interface screen images.

Several types of and methods for computer interface control are known. Conventional keyboards, roller-based controllers such as “mice” and trackballs, integral stick pointing devices, and touchpads, for example, have all been described and used. In order to provide input to the computer, however, these devices all depend upon direct contact between the hand of the computer user and the interface controller.

Direct contact between the user's hand and the interface controller can be disadvantageous. For example, contact between bare hands and interface controllers can lead to unsightly and unhealthy conditions as fingerprints, germs, and other contaminants are left behind. Such direct contact can also cause equipment malfunctions as oil left on the controller by the user's hand builds up and retains dirt, etc., which works its way into mechanical controls and electrical contacts.

Variations on these known devices have been proposed. U.S. Pat. No. 6,072,466 to Shah, for example, describes a specially-adapted mouse or trackball type device adapted to project upon a computer interface screen an image of a control device such as a hand or claw, to facilitate interaction with games and similar items. U.S. Pat. Nos. 6,067,079, 5,933,134, 5,872,559, 5,835,079 and others to Shieh describe refinements of the well-known touchpad controller. But again each of these devices relies upon direct contact between the user's hand and the interface controller.

Physical touchscreens are also known, and can often be found on the front of CRTs and LCD displays in such applications as automatic teller machines (ATMs). Such touchscreens can effectively act as computer interface controllers by providing the screen coordinates of a pointing device, as for example a user's finger, brought into contact or very close proximity (typically approximately ⅛ inch) with the display. Such touchscreens otherwise act in very much the same capacity as the “mouse” type interface controllers commonly found in use with contemporary computer systems, using a detected relative position or coordinates of the pointing device as a means of placing a cursor. Such touchscreens operate through resistive or capacitive means in which the physical touch or near approach of a pointing device is detected through modification of the resistive or capacitive characteristics of the device. This physical contact with the touchscreen is suitable for certain applications, such as bank ATMs, but for some other applications, such as interacting with a projected floating image of a computer screen, is less than useful or elegant. And even where physical contact is generally suitable, it can still cause significant problems. Physical touchscreens can become unappealingly or unhealthily covered with fingerprints, oils, germs, and other contaminants from users' hands, for example. Buildup of fingerprints, dirt, and grease can also impair functionality by reducing the clarity of screen images, especially on physical touchscreens.

Thus it may be seen that a variety of computer interface controllers are known. However, each of these controllers relies on physical contact, or something very close to it, between a human user and a portion of the computer system.

There exist, moreover, applications such as those discussed herein for which interface control which does not require physical contact between the user's hand and the pointing device is highly desirable. In training or simulation applications, for example, in which it is desired to simulate with a very high degree of verisimilitude a user's interaction with a dangerous, unusual, or otherwise difficult environment, it can be advantageous to project a virtual image of the environment and to allow the user to seemingly interact with it in ways which are not satisfactorily simulated when physical contact with an interface controller is required. Similarly, in applications such as industrial “clean” rooms or sterile facilities in medical institutions it can be advantageous to eliminate the requirement for direct contact between a human user and the computer interface controller.

There is thus a need for an interface control device which enables a user to control or give input to a computer or other data processor and which does not require physical touch by the user with the interface device.

### BRIEF SUMMARY OF THE INVENTION

The invention provides an interface controller for a computer or other data processor. The interface controller of the invention does not require physical contact between a pointing device and the controller. Methods and apparatus are disclosed for detecting coordinates associated with the violation of a plane in space by a pointing device such as a user's finger, and providing those detected coordinates for input for controlling a data processor such as a digital computer. The interface controller is especially useful for controlling computers in which the user is presented not with a physical interface screen such as a CRT monitor, but with a virtual image of the screen (which is preferably “real” in the optical sense) or in applications where direct physical contact is not desired—for example, when it is desired to avoid the buildup of fingerprints, oils, dirt, and other contaminants as a result of contact with users' fingers or palms, or where it is important to maintain sterile conditions, such as in medical or other “clean” facilities. Elimination of the need for direct physical contact can also eliminate dangers to the user, such as for example transmission of communicable diseases, or electrocution in applications involving high-voltage electronic machinery.

In one aspect the invention provides a method of acquiring input for a data processor. The method comprises establishing in space a detection plane, determining an at least two-dimensional coordinate position of a pointer upon violation by the pointer of the detection plane; and communicating the position of the pointer to a data processor.

In a preferred embodiment, this method aspect of the invention comprises establishing the detection plane by projecting a planar or substantially planar field of reflectable or otherwise distortable energy in space. In such embodiments determination of the pointer position comprises detecting energy reflected by the pointer upon violation of the field by the pointer. The energy projected to establish the planar field can be of any reflectable or otherwise suitable, distortable type, such as for example visible light or other electromagnetic radiation, or sonic or ultrasonic emissions. Preferred radiation sources include lasers, light emitting diodes (“LED”s), or infrared, ultraviolet, microwave, radio, or other radiation generators.

It should be noted that in general it is only necessary that one “surface” or outermost limit of the region in which energy is radiated (that is, the surface or limit of the region nearest the user or the pointer) be planar, or substantially so. In many cases it does not matter whether the region has substantial depth. Indeed, in embodiments of the invention adapted for the determination of pointer positions in three-dimensional space, it is often preferred that the region have substantial depth behind the planar face. In other words, it is often acceptable, or even preferable, for the detection plane to be backed in space by region of radiated energy having substantial depth.

In some circumstances it is preferred that detection of the pointer position comprise the detection at or from a plurality of points of energy reflected by the pointer, so that the pointer position may be determined by cross-reference, as for example by trigonometric methods. However, this is not always necessary and in some instances the detection of reflected energy from a single point is both sufficient and preferred.

In some cases it is useful to provide an image of an interface screen substantially coincident with the detection plane, so that it appears that a finger or other pointing device passed into or through the detection plane is moved into contact with the screen image. This is particularly useful where the screen image is virtual, as for example an optically “real” image of a screen or a computer-created environment reflected by one or more mirrors so as to appear to exist in space before the user.

Another useful option in practicing this method aspect of the invention is to use input derived from the position of the pointer to effect a change in an appearance of the interface screen, as for example by means of a feedback loop. For example, an operating system used to control the data processor can use the pointer position as input to provide feedback (as for example graphic feedback) to the interface screen for use by the user in controlling the data processor, as is commonly practiced with conventional operating systems, especially graphically-oriented systems in which options and designations of various selections, for example, are shown by changes in appearance of screens. For example, it is common in many data processing systems now in use to indicate or confirm user selections or instructions by changing the appearance of menu items “buttons” presented on the screen.

Communication of the pointer position to the data processor may be accomplished in any suitable way. A number of known means similar to those commonly used in prior systems to communicate position and detection information to the processor are suitable. For example, electromagnetic signals from the various types of detection devices may be communicated directly or indirectly to the data processor, by wires, infrared, or other suitable connection, and converted, either by the processor or by the controller prior to communication to the processor, to screen coordinate positions through the use of suitable software programs. Optionally the processor's system clock may be used to provide time and timing information to complete signals, such as intervals between plane violations by the pointing device, which may be used in conjunction with pointer position data in a manner analogous to “clicking” or “double clicking” used with the well known Microsoft Windows and other currently popular operating systems.

Pointer position data may be analyzed for an event (as for example by considering both the coordinate position of the detection plane violation and the time or duration of the violation, or of successive violations) either through computer software or through suitable hardware, such as a dedicated board featuring a CPU, a field programmable gate array (FPGA), or a digital signal processor. In embodiments comprising a dedicated board, the board may be internal to the computer or may be external and connected to the computer through a serial interface such as a universal serial bus (USB). This last is ideal for many applications as the system can be set up to act in a manner closely analogous to that of a computer's mouse.

Optionally the position of the pointer is developed in three coordinates. This may be done in a number of ways. For example, a bank or series of two-dimensional detection planes, preferably substantially parallel to each other, is established. In such embodiments two of the pointer coordinates are developed or detected as described for a two-dimensional system, with the third coordinate, typically thought of as a depth coordinate, being developed by determining how many of the series of planes have been violated. As another example, a single detection plane is established, for example by means of a rastering device or diffractive line generator, with a generated energy beam being swept through a three-dimensional detection field. By correlating the position and orientation of a projected or radiated beam at a given moment with reflected energy deflected from the original beam by the pointer, a violation of the detection field and the position of the pointer at any given time may be detected.

In a further aspect the invention provides an interface controller for controlling a data processor, the data processor generally comprising an operating system (“operating system”, as used herein, meaning any software, data structure, command set, or firmware suitable for passing input/output information to a data processor or any data processor application) and an interface screen. The controller comprises a plane violation detector and means for communicating the position of the pointer within the plane at the time of the violation to the data processor. The plane violation detector is adapted to detect violation by the pointer, which might include a finger or any other natural or artificial pointer, of a plane in space, and to determine an at least two-dimensional coordinate position of the pointer at the time of the plane violation. The pointer position may then be used as input for controlling the data processor, optionally in conjunction with other information, such as for example time or relative time between violations.

A preferred class of controllers according to the invention comprises a radiator adapted to radiate reflectable energy within a planar or substantially planar field, and thereby to define the plane in space, and a reflected radiation detector for detecting energy reflected by the pointer upon violation by the pointer of the energy field that defines the plane.

The energy used to create such a planar field may be of any reflectable or otherwise deflectable or distortable type suitable for the purposes described herein. The selection of a suitable type for any particular purpose will depend, among other factors, upon the application to which the embodiment is to be put and the type of reflected radiation detectors used in the particular embodiment. For interface controllers intended for use in controlling computers and other data processors under human control, visible and nonvisible electromagnetic radiation and sonic (including ultrasonic) radiation are included among suitable types. Infrared sources emitting radiation in the range of 750 nanometers or more are particularly well suited to controllers for such applications, as they are invisible to human users and harmless at power or intensity levels satisfactory for controlling most contemporary data processors. Lasers and LEDs also serve very well. Magnetic and/or capacitive field generators are also suitable.

One particularly effective method of projecting reflectable energy into a substantially planar field is through the use of a planar beam spreader, as for example in conjunction with a laser or LED light source. Examples of beam spreaders suitable for use with the invention comprise resonant, galvanometric, acousto-optic, and similar laser scanners; cylindrical lenses, and diffractive optical elements known as diffractive line generators (DLGs). It is found that in configurations comprising scanners the use of scanners having scanner frequencies of 60 Hertz or greater is advantageous, as this provides sufficiently timely, reliable, and consistent detection of plane violations to control most data processors. Further examples of suitable reflectable energy plane generators include transmissive and reflective hologram and holographic optical elements.

It is advantageous for beam spreaders used in apparatus of the type disclosed herein to fan or spread beams of radiated energy, such as laser beams, into as thin a plane as possible. This maximizes the intensity of radiated energy within the plane, and provides better consistency and reliability in detection of plane violations.

The reflected or deflected radiation detector used for this class of embodiments of the invention may be of any type suitable for the purpose. The selection of a suitable type for any particular purpose will depend, among other factors, upon the application to which the embodiment is to be put and the type of radiation generators used in the particular embodiment. For interface controllers intended for use in controlling computers and other data processors under human control, in which visible and nonvisible electromagnetic radiations are to be used as reflectable energy, video cameras, scanners, and one-dimensional and two-dimensional position sensing detectors, including particularly photodetectors, have been found to serve very satisfactorily, either alone or in combination with each other.

Interface controllers according to the invention are advantageously used in conjunction with virtual screen images, by providing a screen image such that it is or appears to be coincident, or substantially so, with the planar field of reflectable energy generated for the plane violation detector. This is accomplished through the use of a virtual screen image projector. Any device or means suitable for projecting or otherwise presenting or producing a virtual screen image within such a plane is suitable for use with the invention as a virtual screen image projector. Particularly satisfactory results have been accomplished, however, through the use of an image source, a beamsplitter, and an optical reflector. In such embodiments of the invention it is often useful to present the screen image such that it appears to a user using a pointing device with the controller that the pointing device touches the screen image when the pointing device violates the plane in space. This is advantageous, for example, in embodiments of the invention used for interactive training, simulations, and gaming.

Any image source capable of projecting or presenting a screen image consistent with the purposes disclosed herein will serve. The invention is particularly well suited for use with standard CRT or LCD computer screen monitors. However, an additional preferred class of image sources comprises multi-planar volumetric displays (MPVDs), which can provide three-dimensional images. MPVDs well suited to use with the invention herein are described co-owned in U.S. Pat. No. 6,100,862, issued Aug. 8, 2000, and entitled Multi-Planar Volumetric Display System and Method of Operation. The specification of that patent is incorporated by this reference as if set out herein in full.

In another aspect the invention provides data processing systems comprising interface controllers of the type described herein. Such systems comprise data processors, interface controllers, interface screens, and operating systems, which interact with the apparatus as described herein, and in the manner described herein, to provide effective control of computers or other data processors without physical contact between the user and the computer, and which are especially well adapted for use with projected virtual screen images as described herein.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a schematic diagram of a data processing system comprising an interface controller according to the invention.

FIG. 2 is a schematic perspective view of a data processing system comprising an interface controller according to the invention.

FIG. 3a and FIG. 3b are schematic side and front views, respectively, of a data processing system comprising an interface controller according to the invention.

FIG. 4 is a schematic side view of a data processing system comprising an interface controller according to the invention.

FIG. 5 is a flowchart of a method of acquiring input for a data processor according to the invention.

FIG. 6 is a schematic perspective view of an interface controller according to the invention.

FIG. 7 is a schematic perspective view of an interface controller according to the invention.

FIG. 8 is a schematic perspective view of an interface controller according to the invention.

FIG. 9 is a schematic representation of amplitude characteristics of reflected energy detected by a reflected radiation detector according to the invention.

FIG. 10 is a schematic perspective view of an interface controller according to the invention.

FIG. 11 is a schematic perspective view of an interface controller according to the invention.

### DETAILED DESCRIPTION OF THE PREFERRED EMBODIMENTS

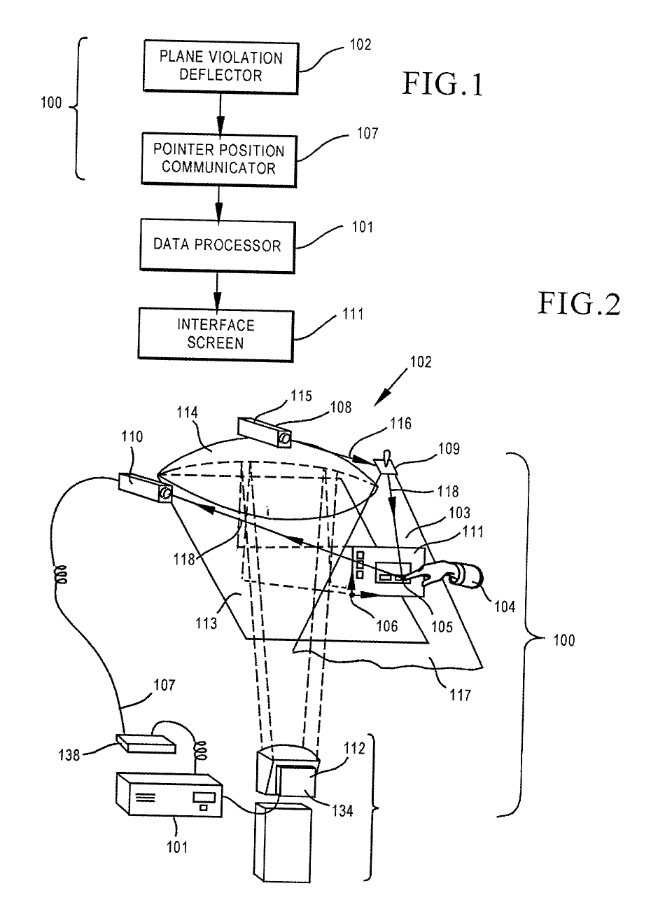

A data processing system comprising an interface controller according to the invention is shown schematically in FIG. 1. Interface controller 100 comprises plane violation detector 102 and pointer position communicator 107; as described herein plane violation detector 102 and communicator 107 detect violation of a plane in space by a pointer and provide pointer position data to data processor 101, which uses such data as input for controlling the data processor and optional interface screen 111. It may be seen that the system user (not shown) can be effectively positioned to complete a loop between interface screen 111 and plane violation detector 102 by using information presented on interface screen 111 to control data processor 101, which in turn modifies screen 111, presenting further possibilities to the user.

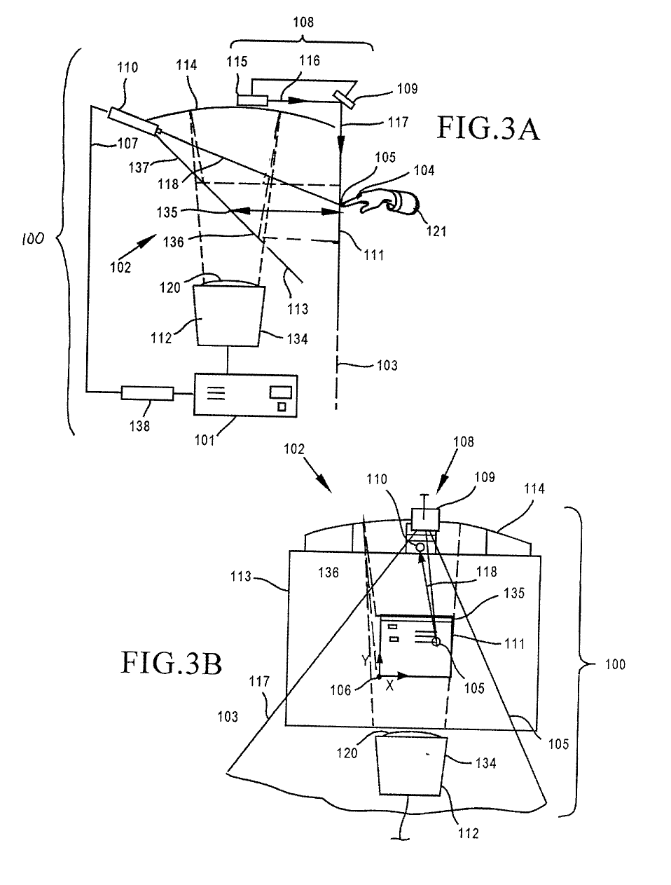

A preferred embodiment of a system according to the invention is shown in FIGS. 2, 3a, and 3b. Interface controller 100 is configured to provide coordinate position 105 of pointer 104 to data processor 101 as the pointer violates plane 103, for use as control input.

Interface controller 100 of FIGS. 2, 3a, and 3b comprises plane violation detector 102 and means 107 for communicating information relating to coordinate position 105 from plane violation detector 102 to data processor 101. Plane violation detector 102 comprises radiator 108 and reflected energy detector 110. Radiator 108, by means of energy generator 115 in the embodiment shown in the Figures, generates energy beam 116, which projects into beam spreader 109. Beam spreader 109 spreads beam 116 into planar energy field 117 to define plane 103 in space. A user wishing to provide control input to data processor 101 causes pointer 104 to violate plane 103, causing reflectable energy ray 118 to be reflected by the pointer to reflected energy detector 110. Reflected energy detector 110 provides coordinate data relating to position 105 of pointer 104 as it violates plane 103 to data processor 101 by means of communication means 107. Data processor 101 uses the information so passed as control input.

Particularly for graphics-oriented operating systems of the type commonly used in current data processing systems, an important type of information relating to position 105 of pointer 104 as it violates plane 103 is the pointer's relative coordinate position. Such position may be determined, for example, relative to x-y coordinate system 106, and used by processor 101 to control software processes. Coordinate position and other information communicated by reflected energy detector 110 to processor 101 may comprise raw electrical signals, for further processing by processor 101, or may comprise or signals processed into the form of formatted coordinate position data suitable for direct use by the processor, or any other form suitable for use by the data processor.

In the embodiment shown in FIGS. 2 and 3a and 3b, data processor 101 comprises optional virtual screen image 111 and interface controller 100 comprises a virtual screen image projector. The virtual screen image projector comprises image source 112, beamsplitter 113, and optical reflector 114. A screen image is generated by data processor 101 in any suitable fashion, as for example any one of those currently used by common data processing systems, but instead of being displayed directly to the user in a hard flat panel or CRT screen is projected by image source 112 through beamsplitter 113 into reflector 114, back into beamsplitter 113, and into plane 103 where it appears as a floating virtual image, such that pointer 104 appears to touch the screen image as it passes into and violates plane 103.

Communication means 107 for communicating information related to the position of the pointer may comprise software, hardware, or both. For example, pointer position data may be analyzed for an event (as for example by considering both the coordinate position of the detection plane violation and the time or duration of the violation, or of successive violations, and optionally of other factors, such as the size of the pointer) either through computer software or through a dedicated board featuring a CPU, a field programmable gate array (FPGA), or a digital signal processor (DSP). Examples of CPU boards suitable for use as dedicated drivers for the interface controller of the invention include single board Pentium computers such as those available from SBS Technologies (www.sbs.com) or Advantech (www.advantech.com). Examples of suitable FPGAs include Virtex™ devices available from Xilinx (www.xilinx.com) or FLEX™ devices available from Altera (www.altera.com). Examples of suitable DSPs include the Texas Instruments TMS320DSP (available from Texas Instruments, www.ti.com) or the Analog Devices Sharc DSP (www.analog.com). Controller hardware may be internal to the computer or may be external and connected to the computer through a serial interface such as a universal serial bus (USB). This last is ideal for many applications as the system can be set up to act in a manner closely analogous to that of a common “mouse”-type pointing device. The system may also provide coordinate transformations to account for image distortion due to the camera being off axis (keystone distortion). Also thresholding may be used to eliminate non-events, that is events such as pointer plane violations whose signal does not exceed a certain pre-set threshold intensity level or duration. Principles of thresholding are known, being commonly used with other, known, interface controllers, and the setting of suitable thresholding levels for use in conjunction with the methods and apparatus disclosed herein will depend on the desired results as will be understood by the designer having ordinary skill in the art.

Additional input devices or interface controllers may also be used in conjunction with the invention. For example, voice recognition equipment, infrared or laser pointers, and conventional interface controllers such as keyboards, mice, and trackballs, may be used to enhance or expand the capabilities of the controller according to the invention, or to provide additional or parallel input means.

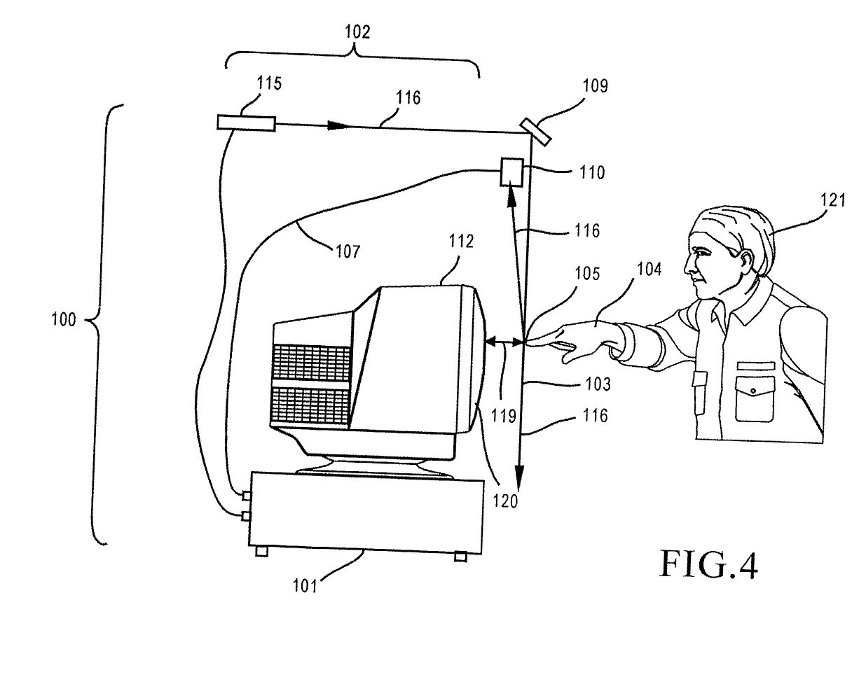

FIG. 4 is a schematic side view of a data processor comprising an interface controller according to the invention. The interface controller in FIG. 4 is shown in combination with a physical screen image presented on face 120 of image source 112, which comprises a CRT display. Plane 103 is disposed between user 121 and the screen image presented on face 120 of the image source, but is separated from any physical component of data processor 101 or of interface controller 100 such as face 120 by a distance 119 sufficient to ensure that in normal use pointer 104 will not physically contact face 120 before a violation of plane 103 by pointer 104 is detected. To say that plane 103 is placed or disposed in space is to say that it is disposed at least such a distance 119 away from any physical component of the data processing system. Normal use means such use as is reasonably required to operate the interface controller and thereby provide control input to the data processor. For an interface controller intended to be operated by a human user using one or more fingers as a pointer, for example, a distance of approximately one-half inch (½″; about 1.25 centimeters) or more is generally sufficient. Maximum separations between the disposition of the detection plane and system components is limited, in general, only by the need to be able to correlate the position of the pointer with the screen image.

In spreading a radiated energy beam to form a planar energy field 117 it is likely that an imperfectly planar field will result. Beam spreaders typically introduce some scatter and other slight non-planar variations. This is of no important consequence, however, so long as the field is sufficiently concentrated and sufficiently planar to ensure that violations of the plane by pointers 104 are sufficiently consistently detected, and the position of the pointer on violation determined, with sufficient certainty and precision to allow the data processor to use the pointer position information for its intended purpose. The intended purpose for the use of such information will vary from application to application, but will be sufficiently clear to the system designer having ordinary skill in the art of designing such systems that it will not be difficult to establish what is and is not a sufficiently planar field.

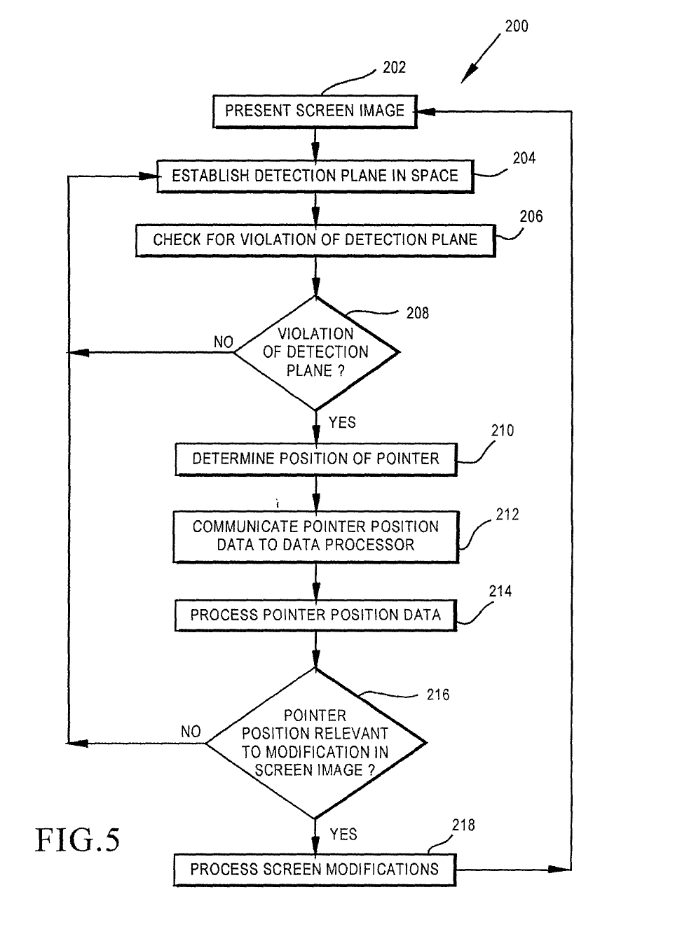

FIG. 5 is a flowchart illustrating a process of acquiring input for a data processor according to the invention. The order of the steps presented in the Figure is not important, or fixed, except where one step must inherently follow another. Only in such situations is the process order considered to be relevant or limiting on the scope of the invention disclosed herein. In the embodiment shown process 200 begins at 202 with presentation to a user of a screen image generated by a data processor, either, as discussed, on a physical screen or as a virtual screen image. At 204 a detection plane is established, preferably in a position between the user and the screen image, such that it appears to the user that he or she is interacting with and preferably touching the screen with the pointer as he or she uses the pointer to provide control input to the data processor. To this end the detection plane is preferably established, where a physical screen image is presented, relatively close to the screen, but not closer than will allow the pointer to be used without physically contacting the screen. Where a virtual screen image is used, it is preferred that the detection plane be established in or close to the focal plane of the projected virtual screen image.

At 204 a check is made for violation by a pointer of the detection plane. Preferably this check is made by a plane violation detector in accordance with the apparatus aspect of the invention disclosed herein. If no violation of the detection plane has occurred, the process of maintaining the screen image and the detection plane, and checking for violations of the detection plane, is repeated at least until a violation is detected. To this end the location of the terminus of the return arrow shown in the Figure as emanating from decision block 208 and terminating at block 204 is to some degree arbitrary, especially as regards blocks 202, 204, and 206, and dependent upon the architecture of the data processor and its operating system, as will be understood by those of ordinary skill in the design of such systems. For example, both the screen image presented at 202 and the detection plane at 204 may be thought of as permanently established, at least until a change in the screen image occurs, or they may be thought of as continually refreshed or reconstructed.

Optionally decision 208 comprises an evaluation of whether a violation of the detection plane rises above a predetermined threshold level, and thereby comprises a “vaild” plane violation, as discussed herein, to help reduce or eliminate unwanted inputs to the data processor. For example, a penetration of the detection plane of a given strength but for less than a desired duration might be considered a non-event and not treated as suitable for providing input to the data processor. Likewise a penetration or reflected energy detection of less than a desired strength might be treated as a nonevent.

If a valid plane violation is detected, at 210 the position of the pointer, and optionally the time of the initial pointer violation and an interval between successive violations, is determined and at 212 pointer position data is communicated to the data processor. Pointer position data and optional timing data may be reported to the data processor in raw signal form, such as voltages, from a detection apparatus, or may be processed prior to communication to the data processor and reported in the form of coordinate data. In those embodiments of the invention in which the detection plane is disposed between the user and a screen image, it is preferred that the pointer position be reported in such form that the data processor may ultimately use or interpret the position as a relative position on the screen image presented, whether the data is processed by the detection apparatus or by the processor itself.

At 214 the pointer position data is processed by the data processor and preferably used by the data processor as control input. For example, the data processor may interpret the pointer position data as input in the same manner as that derived from a mouse, trackball, or other conventional pointing device, based on cursor position and for example the virtual activation of a control button through the use of signal or graphical feedback as discussed herein. This can be accomplished, for example, by using the pointer position in conjunction with timing information from the data processor's system clock. For example, the position of the pointer upon violation of the detection plane, the duration of the plane violation by the pointer, and the lapse in time between successive violations of the plane in a single location can be used in a manner analogous to a “double click” feature on a conventional mouse using a graphical windows-type operating system.

Pointer position data may be analyzed for an event (as for example by considering both the coordinate position of the detection plane violation and the time or duration of the violation, or of successive violations) either through computer software or through various hardware components such as a dedicated board featuring a CPU, a field programmable gate array (FPGA), or a digital signal processor.

At 216 a determination is made as to whether the pointer position data communicated to the data processor, as processed by the data processor, is relevant to or necessitates a change in the appearance of the screen image presented to the user. If no screen image change is required, the process returns to monitoring the detection plane at 206 for another violation by the pointer, preferably by reestablishing the detection plane or ensuring at 204 that the plane has been maintained. If a screen image change is necessitated, at 218 the required screen modification is processed, preferably by the data processor, and at 202 the modified screen is presented to the user.

As explained herein, a virtual touchscreen is a device that detects the coordinates (Cartesian x,y, polar, or any other suitable type) of a user's fingertip or other pointer when it breaks a certain plane in space. A number of electro-optical methods of obtaining this effect are disclosed in the Figures and in the following examples. Each of the example methods features a narrow bandwidth laser or LED beam that is fanned out in one direction to form an x,y plane of light coincident with the detection plane. The fanning of the beam is accomplished by either a laser scanner (resonant, galvanometric, acousto-optic, etc.), a cylindrical lens, or a diffractive optical element called a diffractive line generator (“DLG”). In the direction perpendicular to the fan the beam is maintained with a minimum size to maximize the light intensity. Among other effects, this tends to improve the consistency and reliability of input. The laser or LED may be of any wavelength; however near infrared wavelengths (approximately 750 nm or more) have the advantage of being invisible to the user.

The invention is not considered to be limited, however, to the embodiments described in the Examples. Any system or method which will accomplish the functions and purposes described herein is considered to lie within the scope of the invention.

### EXAMPLE 1

An interface controller according to the invention. The components are configured as shown in FIGS. 2 and 3a and 3b. Plane violation detector 102 comprises a laser radiation source, such as a 2 milliWatt, 850 nanometer vertical cavity surface emitting laser (VCSEL), model VCT-B85B20 from Lasermate Corporation of Walnut, Calif.; a video camera, such as a complimentary metal oxide semiconductor (CMOS) -based or charge coupled device (CCD), or other, preferably simple and low cost video camera, for example, an Intel PC Camera with a USB interface available from Intel (www.intel.com); and a beam spreader selected from the group comprising DLGs, cylindrical lenses, and scanners, such as a galvanometric laser scanner, model 6860 from Cambridge Technologies (www.cambridge-tec.com) or one of the CRS series available through GSI Lumonics (www.gsilumonics.com). Beamsplitter 113 comprises a 50% reflective aluminum coating on upper surface 136 and an anti-reflective coating on lower surface 137. Optical reflector 114 comprises a spherical mirror having a 54-inch radius of curvature.

Pointer coordinate data is communicated to data processor 101 by means of an externally-mounted dedicated Pentium-class SBS Technologies or Advantech CPU board 138, which provides the coordinate date in form suitable for use by data processor 101's operating system without substantial further processing.

The above components are disposed so as to facilitate control by a user 121 of data processor 101 through interaction with virtual screen image 111 of image source 112. Radiation generator 115 and beam spreader 109 are disposed so as to create a planar detection field 103 in front of user 121 by directing beam 116 toward the user and into beam spreader 109, which both reflects beam 116 downward and spreads it into a substantially flat planar field 103. On the other side of planar field 103 from the user, and with center 135 disposed at approximately the focal distance of reflector 114 away from the user, angled at 45 degrees from the horizontal line of user's 121 sight, is beamsplitter 113.

Image source 112 is disposed behind and below beamsplitter 113, in an orientation orthogonal to the user's horizontal line of sight, two focal lengths of optical reflector 114 from vertex 140 of the optical reflector. This results in the presentation at plane 103, before user 121, of a virtual, full-sized, optically real image 111 of the screen presented on face 120 of image source 112

Detector 110 is disposed in a position from which it can satisfactorily receive radiation reflected from pointer 104 on violation of plane 103, and process received reflected radiation to determine the coordinate position of the pointer. Beam 16 is fanned out to form the detection plane 103 as described above. The video camera views the detection plane from the opposite side as the user and is equipped with a narrowband bandpass filter with a peak transmission wavelength equal to the laser's wavelength. An example of a suitable filter is a model number K46-082 filter, with a center wavelength of 850 nanometers 10 nanometer bandwidth, available from Edmund Scientific, www.edsci.com. Use of the filter dramatically enhances the system's operation by maximizing the strength of the signal seen by the camera at the laser wavelength and eliminating other wavelengths of light that might interfere with the signal detection.

When the user reaches out to use his finger, for example, as a pointer, and violates the light plane, light will be scattered by the user's finger into the lens of the video camera and a bright signal will be seen on the video camera. The image from the camera may be analyzed for the brightest pixels. These brightest pixels are located at the x,y coordinates of the user's finger and constitutes the equivalent of a “mouse event” (such as cursor “pointing” and button “clicking”) on a personal computer.

The signal from the video camera is analyzed for an event by means of the dedicated board, which features a digital signal processor using suitable software. The board is external to the data processor and connected to the data processor through a universal serial bus (USB). The software analyses each frame of video in the following manner: Due to the angular offset of the camera from the detection plane, the detection plane will cover a trapezoidal area of the video frame. This trapezoidal area is processed pixel by pixel and the brightest pixel at a wavelength (i.e. color) appropriate to the radiation source is found. In similar pixel-by-pixel manner an average radiation return value for all pixels is calculated. The brightest value is compared to the average value; if the difference between the brightest and average values is greater than a predetermined threshold value, then a plane violation is considered to have been detected. The x,y coordinates of the brightest pixel in the trapezoidal area are transformed into x,y coordinates on the detection plane by standard trigonometric techniques, communicated to the data processor, and thereafter used as input to control the data processor. The relative strength or brightness of the detected signal can also be used to determine the size of the pointer, where desired.

### EXAMPLE 2

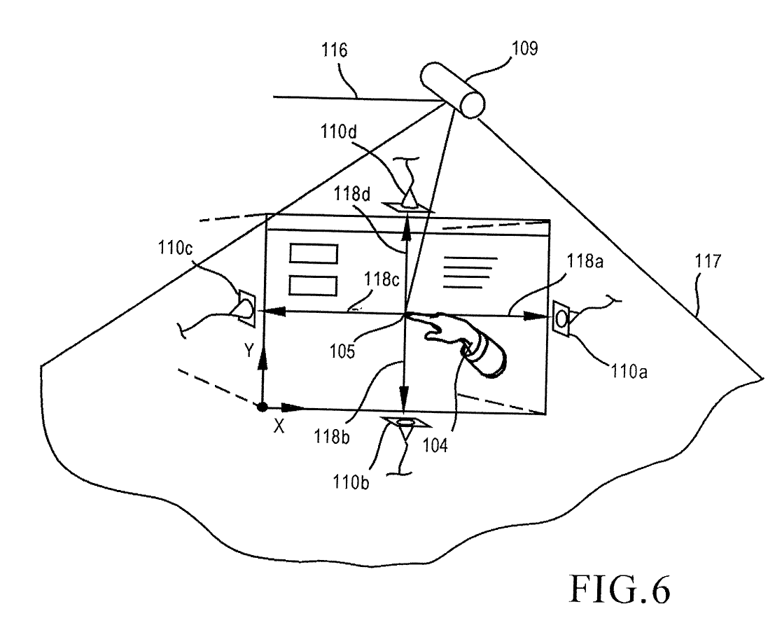

An interface controller according to Example 1, but reflected radiation detector 110 comprises a two-dimensional (2D) position sensing detector (PSD) in place of the video camera. A 2D PSD such as a UDT Sensors, Inc., model DL-10 PSD comprises a semiconductor photodetector with a central anode and two pairs of cathodes 110a, 100b, 110c, and 110d arranged within the detection plane to receive reflected energy beams 118a, 118b, 118c, and 118d as shown partially in FIG. 6. The four resulting analog electrical signals from the four cathodes can be analyzed to compute the centroid of the light falling on the PSD. If the cathodes are assigned references x1, x2, y1, and y2, then the x coordinate X of the pointer position is:

X=(x1−x2)/(x1+x2)

and the y coordinate Y is

Y=(y1−y2)/(y1+y2)

where X=Y=0 is defined as the center of the PSD detection system. Considering the effect of the imaging lens allows the x,y location of the centroid of the reflected energy relative to the PSD to be mapped to the x,y location of the pointer in the detection plane.

An advantage of this system relative to that of Example 1 is that the PSD returns directly the location of the “bright” spot corresponding to the location of the pointer's violation of the detection plane, thereby eliminating the computational load of processing the video camera image.

### EXAMPLE 3

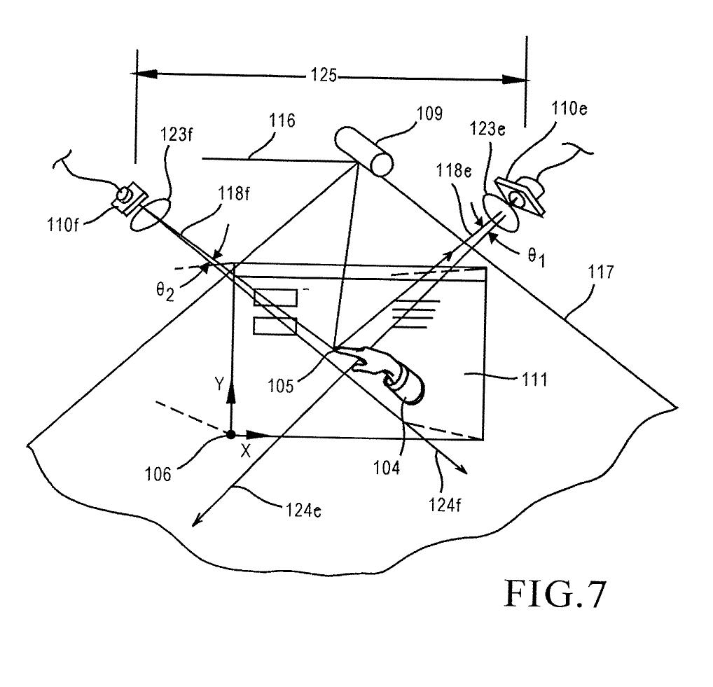

An interface controller according to Examples 1 and 2, except that the reflected radiation detector comprises a pair of one-dimensional (1D) position sensing detectors (PSDs) in place of the video camera and the 2D PSD. Beam spreader 109 comprises a DLG. The 1D PSDs 110e and 110f, comprising for example a pair of UDT Sensors, Inc., model SL-15 1 mm×15 mm linear sensors are provided with narrowband bandpass filters and are mounted coplanar to the DLG, as shown in FIG. 7. In this configuration the centroids from each PSD, taken in combination with the focal length of the lenses 123e and 123f disposed in front of them, allows for the determination of angles θ₁ and θ₂ between bright spot 105 and the optic axes 124e, 124f of the PSD/lens systems. From the angles and the known separation distance 125 between the PSDs the x,y positions of the bright spot—i.e., pointer location—can be calculated using standard trigonometric and geometric techniques. As with the configuration discussed herein, the actual analysis or determination of the pointer position may be carried out in a variety of manners.

### EXAMPLE 4

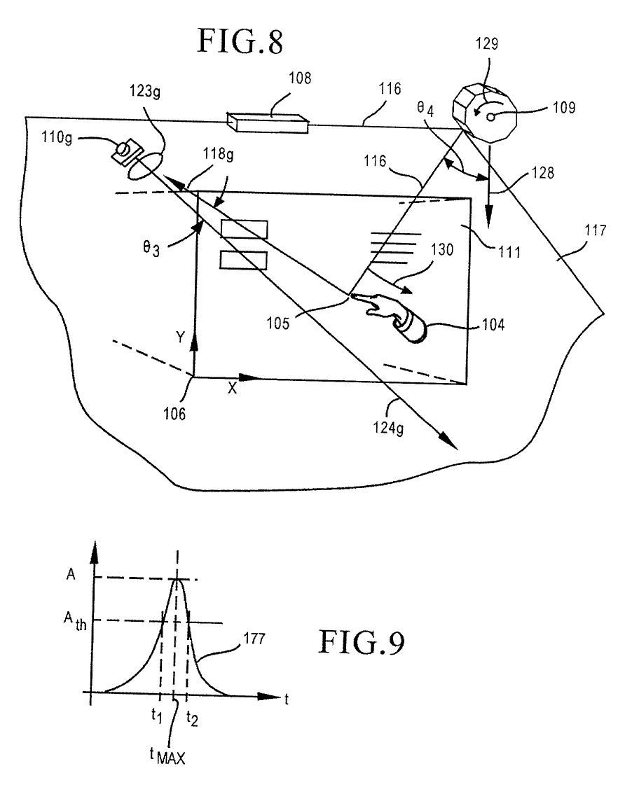

An interface controller according to Example 3, except that one of the PSDs is removed and the DLG is replaced with a laser scanner 109, as shown in FIG. 8. A Cambridge Technologies model 8060 galvanometric laser scanner, operating at 30 Hz with a 45 degree scan angle is an example of a suitable scanner 109. The remaining PSD's signal is analyzed in both amplitude (which returns the angle θ₃ with respect to the PSD's optical axis 124g) and in time (which is used to compute the angle θ₄ with respect to the laser scanner and an arbitrary reference 128). Again both angles may used with distance 125 to determine the x,y position of the bright spot through standard trigonometric and geometric methods.

The amplitude characteristic for the electrodes in the activated region of the active area is shown in FIG. 9. As scanner 109 in FIG. 8 rotates in the direction of arrow 129 to raster beam 116 through arc 130 and form planar radiation field 117, beam 116 encounters pointer 104, causing light to be reflected along beam line 118g to PSD photodetector 110g. A plot 177 of received radiation of the radiated wavelength is shown in FIG. 9 as a function of time. At time t=0 no radiation is received. As time progresses radiation begins to be received, the amplitude A of received radiation surpassing threshold level Aₜₕ at time t₁, peaking at time tₘₐₓ, and dropping below Aₜₕ at time t₂ and eventually returning to zero level. (So long as amplitude A of the received radiation exceeds threshold value Aₜₕ, optionally for a minimum length of time less than or equal to t₂−t₁, a plane violation is considered to have taken place). PSD 110g reports the amplitude of incoming reflected radiation levels and angle θ₃, between PSD optical axis 124g and beam path 118g, to dedicated external CPU board 138 (see FIG. 2), which uses the amplitude and the value of θ₃ in conjunction with time data provided by the CPU's or data processor 101's system clock to determine the angular position of scanner 109 and the coordinate position 105 of pointer 104, and then reports position 105 to data processor 101 for use as control input.

### EXAMPLE 5

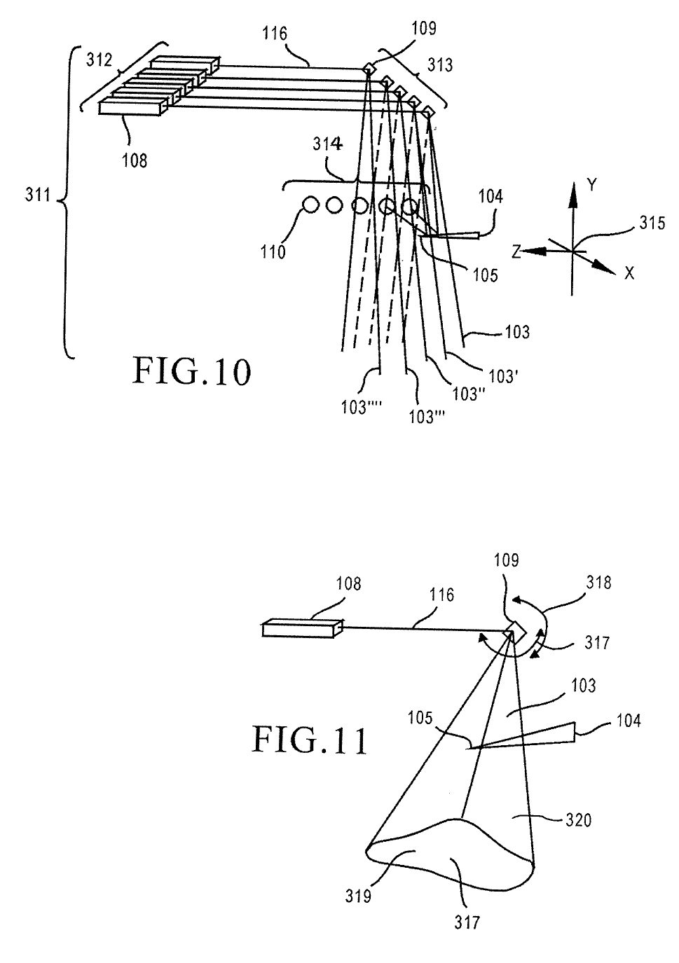

An interface controller according to Example 1, except comprising a plurality 311 of plane violation detectors 102 adapted to detect violation of a succession of substantially parallel planes 103 in space by a pointer. As shown in FIG. 10, the interface controller comprises bank 312 of radiation sources 108, such as for example a series of narrow bandwidth lasers, each adapted to emit light of a wavelength distinct from the others, and bank 313 of beam spreaders, each configured to spread a beam 116 from one of sources 108 into one of a succession of substantially parallel planes 103, 103′, 103″, 103′″, and 103″″, such that each plane 103 is created by a spread beam from a distinct one of sources 108, and comprises energy (e.g., laser light) of a distinct frequency. Upon violation of one or more of planes 103, pointer 104 reflects radiation defining the violated planes from successive energy sources 108 into bank 314 of detectors 110. Each of detectors 110 is adapted to detect radiation of a different wavelength, each corresponding to one of generators 108. Detectors 110 comprise, for example, a set of video cameras having narrow bandpass filters, as described. By determining which wavelengths of energy have been deflected into detectors 110, it is determined which of planes 103-103″″ has been violated, so that a third dimensional coordinate (often thought of, for example, as a depth or “2” coordinate, as shown on reference axes 315 in FIG. 10) may be determined in addition to any dimensions determined in the manners described above. The third dimensional coordinate may then be coupled with the two planar coordinates determined in accordance with the above to determine a three-dimensional coordinate position 105 of the pointer 104.

### EXAMPLE 6

An interface controller according to any of Examples 1-4, except that beam spreader 109 is adapted to oscillate about axes 317, 318, as shown in FIG. 11, in such manner as to raster beam 116 through three-dimensional region or field 319, planar face 320 of which comprises detection plane 103. By simple extension of the methods of detecting and, for example, trigonometrically analyzing radiation reflected by pointer 104 described above, the three-dimensional coordinate position 105 of pointer 104 within field or region 319 is determined.

It is noted that none of the disclosed systems require surrounding frames for establishment of the detection plane, such as are required for some prior art systems such as the capacitive or resistance-based physical touchscreens described as in use for ATMs and the like. Rather, the detection plane is established by means of as few as one energy source, and single beam being suitable for spreading into a planar field. The elimination of the need for this encompassing frame is a substantial improvement, and allows for much greater flexibility in the design and installation of systems. It also improves reliability and maintainability of systems of the type described.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. An interface controller for controlling a data processor, the controller comprising:
a plane violation detector adapted to detect violation of a plane in space by a pointer, and to determine an at least two-dimensional coordinate position of said pointer within said plane at a time of said violation; and
means for communicating said position of said pointer within said plane at said time of said violation to a data processor, for use in controlling said data processor.

2. The controller of claim 1, wherein said plane violation detector comprises:
a radiator adapted to radiate reflectable energy within a planar field and thereby define said plane in space; and
a reflected radiation detector for detecting energy reflected by said pointer upon violation by said pointer of said plane.

3. The controller of claim 2, wherein said radiator comprises a source of nonvisible electromagnetic radiation.

4. The controller of claim 2, wherein said source of reflectable energy comprises a laser.

5. The controller of claim 2, wherein said source of reflectable energy comprises a light emitting diode.

6. The controller of claim 2, wherein said radiator further comprises a planar beam spreader.

7. The controller of claim 6, wherein said planar beam spreader comprises a cylindrical lens.

8. The controller of claim 6, wherein said planar beam spreader comprises a diffractive line generator.

9. The controller of claim 2, wherein said reflected radiation detector comprises a video camera.

10. The controller of claim 2, wherein said reflected radiation detector comprises a scanner.

11. The controller of claim 2, wherein said reflected radiation detector comprises a two-dimensional position sensing detector.

12. The controller of claim 11, wherein said two-dimensional position sensing detector comprises a photodetector.

13. The controller of claim 12, wherein said photodetector comprises an anode and two pairs of spaced cathodes.

14. The controller of claim 2, wherein said reflected radiation detector comprises a plurality of one-dimensional position sensing detectors.

15. The controller of claim 14, wherein said position sensing detectors comprise coplanar-mounted photodetectors.

16. The controller of claim 2, wherein said reflected radiation detector comprises a position sensing detector and a scanner.

17. The controller of claim 16, wherein said position sensing detector comprises a photodetector.

18. The controller of claim 16, wherein said scanner is a laser scanner.

19. The controller of claim 1, wherein said controller comprises a virtual screen image projector.

20. The controller of claim 19, wherein said projector projects a virtual screen image such that said image is coincident with said plane in space.

21. The controller of claim 19, wherein said projector comprises an image source, a beamsplitter, and an optical reflector.

22. The controller of claim 21, wherein said image source, beamsplitter, and optical reflector are adapted to project said virtual screen image in said plane in space.

23. The controller of claim 21, wherein said optical reflector is spherical.

24. The controller of claim 21, wherein said image source comprises a screen monitor.

25. The controller of claim 21, wherein said image source comprises a multi-planar volumetric display.

26. The controller of claim 1, wherein said means for communicating said position of said pointer within said plane at said time of said violation to said operating system comprises a field programmable gate array.

27. A data processing system including a data processor, an interface controller, an interface screen, and an operating system;
the interface controller comprising a plane violation detector adapted to detect violation of a plane in space by a pointer, and to determine an at least two-dimensional coordinate position of said pointer within said plane at a time of said violation, said plane disposed between a computer interface screen and a user; and means for communicating said position of said pointer within said plane at said time of said violation to a data processor, for use as input for controlling said data processor.

28. The data processing system of claim 27, wherein said interface screen comprises a virtual screen image and said controller comprises a virtual screen image projector.

29. The data processing system of claim 28, wherein said projector projects said virtual screen image such that said image is coincident with said plane in space.

30. The data processing system of claim 29, wherein said screen image is projected such that it appears to a user using a pointing device that said pointing device touches the screen image when said pointing device violates said plane in space.

31. The data processing system of claim 28, wherein said projector comprises an image source, a beamsplitter, and an optical reflector.

32. The data processing system of claim 31, wherein said image source, beamsplitter, and optical reflector are adapted to project said virtual screen image in said plane in space.

33. The data processing system of claim 31, wherein said optical reflector is spherical.

34. The data processing system of claim 31, wherein said screen image is projected such that it appears to a user using a pointing device that said pointing devices touches the screen image when said pointing device violates said plane in space.

35. The data processing system of claim 31, wherein said image source comprises a screen monitor.

36. The data processing system of claim 31, wherein said image source comprises a multi-planar volumetric display.

37. The data processing system of claim 28, further comprising a feed back system for causing changes in an appearance of said virtual screen image based on input from said user.

38. The data processing system of claim 27, wherein said plane violation detector comprises:
a radiator adapted to radiate reflectable energy within a planar field and thereby define said plane in space; and
a reflected radiation detector for detecting energy reflected by said pointer upon violation by said pointer of said plane.

39. The data processing system of claim 38, wherein said radiator comprises a source of nonvisible electromagnetic radiation.

40. The data processing system of claim 38, wherein said source of reflectable energy comprises a laser.

41. The data processing system of claim 38, wherein said source of reflectable energy comprises a light emitting diode.

42. The data processing system of claim 38, wherein said radiator further comprises a planar beam spreader.

43. The data processing system of claim 42, wherein said planar beam spreader comprises a cylindrical lens.

44. The data processing system of claim 42, wherein said planar beam spreader comprises a diffractive line generator.

45. The data processing system of claim 38, wherein said reflected radiation detector comprises a video camera.

46. The data processing system of claim 38, wherein said reflected radiation detector comprises a scanner.

47. The data processing system of claim 38, wherein said reflected radiation detector comprises a two-dimensional position sensing detector.

48. The data processing system of claim 47, wherein said two-dimensional position sensing detector comprises a photodetector.

49. The data processing system of claim 48, wherein said photodetector comprises an anode and two pairs of spaced cathodes.

50. The data processing system of claim 38, wherein said reflected radiation detector comprises a plurality of one-dimensional position sensing detectors.

51. The data processing system of claim 50, wherein said position sensing detectors comprise coplanar-mounted photodetectors.

52. The data processing system of claim 38, wherein said reflected radiation detector comprises a position sensing detector and a scanner.

53. The data processing system of claim 52, wherein said position sensing detector comprises a photodetector.

54. The data processing system of claim 52, wherein said scanner is a laser scanner.

55. The data processing system of claim 27, wherein said means for communicating said position of said pointer within said plane at said time of said violation to said operating system comprises a field programmable gate array.

56. A method of acquiring input for a data processor, the method comprising:
establishing in space a detection plane;
determining an at least two-dimensional coordinate position of a pointer upon violation by said pointer of said detection plane; and
communicating said position to a data processor for use as input in controlling said data processor.

57. The method of claim 56, wherein:
establishing said detection plane comprises projecting a planar field of reflectable energy; and
determining said position comprises detecting energy reflected by said pointer upon violation of said field by said pointer.

58. The method of claim 57, wherein said projecting a planar field of reflectable energy comprises projecting a planar field of nonvisible electromagnetic radiation.

59. The method of claim 57, wherein determining said position comprises detecting at a plurality of points energy reflected by said pointer.

60. The method of claim 56, further comprising providing an interface screen image coincident with said detection plane.

61. The method of claim 60, wherein said interface screen image is virtual and said method comprises projecting said virtual interface screen image coincident with said detection plane.

62. The method of claim 60, comprising using said communicated position to effect a change in an appearance of said virtual interface screen.

63. The controller of claim 1, comprising a plurality of plane violation detectors, adapted to detect violation of a succession of substantially parallel planes in space by a pointer.

64. The data processing system of claim 27, the interface controller comprising a plurality of plane violation detectors adapted to detect violation of a succession of substantially parallel planes in space by a pointer.

65. A method of acquiring input for a data processor, comprising:
establishing in space a plurality of substantially parallel detection planes;
determining an at least two-dimensional coordinate position of a pointer upon violation by the pointer of at least one of said planes; and
communicating said position to a data processor for use as input in controlling said data processor.
